(19) United States
(12) Patent Application Publication
(10) Pub. No.: US 2016/0059513 A1
(43) Pub. Date: Mar. 3, 2016

(54) FOLDED COMPOSITE PREFORMS WITH INTEGRATED JOINTS

(71) Applicant: Jonathan Marc Hollander, San Francisco, CA (US)

(72) Inventor: Jonathan Marc Hollander, San Francisco, CA (US)

(73) Assignee: SERIFORGE, INC., San Francisco, CA (US)

(21) Appl. No.: 14/836,563

(22) Filed: Aug. 26, 2015

Related U.S. Application Data
(60) Provisional application No. 62/041,956, filed on Aug. 26, 2014.

(51) Int. Cl. B32B 5/02; B32B 5/26; G05B 19/4097; D03D 25/00

(52) U.S. Cl. CPC B32B 5/024; D03D 25/005; B32B 5/26; G05B 19/4097; B32B 2305/07; B32B 2262/101; B32B 2262/106; D03D 2700/0111

(57) ABSTRACT

Systems and methods fabricate composite preforms in a flat or unfolded format. Following fabrication, the preform is folded and placed in or around a mold for curing. To facilitate folding and produce strong parts, the preform is fabricated with integrated, 3D woven joints at preform edges. These joints connect the folded preform portions to other parts of the preform, such as other unfolded or folded preform portions or internal features. Integrated joints may be flexible to facilitate assembly prior to curing. The unfolded preform design may be generated from a preform model by splitting the preform model at an initial joint location, unfolding the preform model into an unfolded preform, creating joint connectors in the unfolded preform at the initial joint location, determining a fiber layup of the unfolded preform, and generating fabrication data.

### CROSS-REFERENCE TO RELATED APPLICATIONS

This application claims priority to U.S. Provisional Pat. App. No. 62/041,956, filed Aug. 26, 2014, and entitled “FOLDED COMPOSITE PREFORMS WITH INTEGRATED JOINTS,” which is incorporated by reference herein for all purposes.

### BACKGROUND OF THE INVENTION

The present invention relates to the field of fiber-reinforced composite materials, and in particular to methods and devices for manufacturing fiber preforms and finished composite products with complicated three-dimensional shapes. Fiber-reinforced composite materials, referred to herein as composites, are materials comprised of fibers embedded in a matrix material. Typical fibers include but are not limited to glass fibers, carbon fibers (e.g. graphite fibers and/or more exotic forms of carbon, such as carbon nanotubes), ceramic fibers, and synthetic polymer fibers, such as aramid and ultra-high-molecular-weight polyethylene fibers. Typical matrix materials include but are not limited to polymers, such as epoxies, vinylesters, polyester thermosetting plastics, and phenol formaldehyde resins; cement and concrete; metals; and ceramics.

Composite materials often combine high-strength and relatively light weight. In typical composite products, the fibers provide high tensile strength in one or more directions and the matrix material hold the fibers in a specific shape. A set of fibers roughly in the shape of a final product is referred to as a fiber preform. Typical prior fiber preforms are comprised of layers of fibers (often woven or bound into a sheet of fabric) that are cut and arranged into a desired shape. Because fibers and fabrics made from fibers only provide high strength in specific directions, multiple layers of fiber cloth are often stacked in different orientations to provide strength and stiffness optimized for the intended usage of the final product.

Prior composite fabrication techniques cut fibers or fabric and assemble the pieces into a preform approximating the shape of the desired part. The preform is often assembled inside or on a mold, mandrel, plug, or other rigid structure in the shape of the desired finished part. Alternatively, the preform may be fabricated outside of the mold or other rigid structure, and then placed as a unit within the mold or other rigid structure. The process of assembling a fiber preform is referred to as layup. Layup is typically performed by hand, one fabric layer at a time, due to the difficulty in draping fabric over complex forms without wrinkles or other surface defects. As a result, composite manufacturing is time consuming, expensive, and inconsistent.

As an alternative to hand layup, automated layup systems, such as automated fiber placement, automated tape layup, and filament winding can automatically layup fiber preforms in a variety of simple shapes. However, these automated systems have limits on the type of shape geometry that can be fabricated. For example, automated fiber placement, automated tape layup, and filament winding systems can produce fiber preforms in the shape of thin shells, but often cannot produce preforms with internal features, sharp folds or bends, or with complex topology such as multiple branches, tails, holes, and loops.

Conversely, some 3D weaving systems can produce preforms with internal features and complex topology. However, these 3D weaving systems may have minimum feature sizes or critical dimensions. This can limit the applicability of 3D weaving systems, especially for parts including thin shells. For example, a 3D weaving system may have a minimum vertical wall thickness of 5mm This minimum feature size makes it difficult to fabricate parts with uniform, thin walls in different orientations that are less than, for example, 5 mm thick.

Moreover, some 3D weaving system are capable of creating preforms with internal cavities. These systems may place removable support material in internal cavities to support the portions of the preform. However, thin shell parts that enclose large internal volumes would require large amounts of support material.

There is an unmet need for automated fabrication of preforms with fewer geometric restrictions and less support material usage.

### BRIEF DESCRIPTION OF THE DRAWINGS

The invention will be described with reference to the drawings, in which:

FIGS. 1A-1C illustrate an example composite preform with integrated joints that can be folded into a desired preform shape according to an embodiment of the invention;

FIGS. 2A-2C illustrate example composite preforms with additional examples of integrated joints according to embodiments of the invention;

FIGS. 3A-3B illustrate an example composite preform with integrated joints and internal structure that can be folded into a desired preform shape according to an embodiment of the invention;

FIG. 4 illustrates an example composite preform including multiple integrated joints according to an embodiment of the invention;

FIG. 5 illustrates a method for generating unfolded preform fabrication data from a three-dimensional preform model according to an embodiment of the invention; and

FIG. 6 illustrates a computer system suitable for controlling a system for three-dimensional weaving of composite preforms and products with varying cross-sectional topology according to an embodiment of the invention.

### SUMMARY

Embodiments of the invention can fabricate composite preforms in a flat or unfolded format, with thin walls arranged so that their thickness is orientated in the dimension with the smallest minimum feature size. Workers or machines may then fold the preform in or around a mold or other tooling to form the desired preform shape. In folded form, the thin walls may be in any orientation. To facilitate folding and produce strong parts, a 3D weaving system fabricates the preform with integrated joints along and/or near the edges in the preform. These joints are used to connect the folded thin walls to other parts of the preform, such as folded or unfolded preform portions or internal preform features. The integrated joints may be flexible to facilitate assembly prior to curing and rigid after curing to form a permanent connection.

In further embodiments of the invention, the unfolded preform design may be generated automatically or semi-automatically from a three-dimensional model of the preform in its finished, folded for. In one embodiment, a method receives a preform model and optionally a specification of composite fiber orientations. The method splits the preform model at an initial joint location specified by a user or determined automatically using an engineering analysis and optimization, and then unfolds the preform model into an unfolded preform model. In a further embodiment, simulated physical forces based on geometric attributes, such as local curvature, are used to determine the unfolded preform model. An embodiment of the method also creates joint connectors in the unfolded preform at the initial joint location, determines a fiber layup of the unfolded preform, and generates fabrication data specifying the shape, composite fiber orientation, and integrate joint connectors for the unfolded preform.

### DETAILED DESCRIPTION

Embodiments of the invention utilize the capabilities of 3D weaving systems and methods to create composite preforms potentially including thin shells, internal features, and complex topologies. 3D weaving systems and methods, such as those described in U.S. patent application Ser. No. 14/216,406, filed Mar. 17, 2014, and entitled “Methods for Three-Dimensional Weaving of Composite Preforms and Products with Varying Cross-Sectional Topology”; U.S. patent application Ser. No. 14/216,472, filed Mar. 17, 2014, and entitled “Systems for Three-Dimensional Weaving of Composite Preforms and Products with Varying Cross-Sectional Topology”; both of which are incorporated by reference herein for all purposes, are capable of creating composite preforms with complex topology and internal features.

These and other 3D weaving systems and methods may include minimum feature sizes. For example, a 3D weaving system may have a minimum horizontal wall thickness (e.g. the minimum vertical thickness of a horizontal structure) of 0.2 mm and a minimum vertical wall thickness (e.g. the minimum horizontal thickness of a vertical structure) of 5 mm

To overcome these limitations, embodiments of the invention can fabricate preforms in a flat or unfolded format, with thin walls arranged so that their thickness is orientated in the dimension with the smallest minimum feature size. For example, a preform may be fabricated with thin walls arranged horizontally to take advantage of the minimum horizontal wall thickness of 0.2 mm. Workers or machines, such as robotic manipulators, can then fold the preform's thin walls to form the desired preform shape. In folded form, the thin walls may be in any orientation. To facilitate folding and produce strong parts, the 3D weaving system fabricates integrated joints along and/or near the edges of the thin walls in the preform. These joints are used to connect the folded thin walls to other parts of the preform, such as other folded thin walls, internal features, or unfolded portions of the preform. For some 3D weaving systems, such as those referenced above, the time and expense required to fabricate composite preforms does not depend substantially on the geometric complexity of the preform; therefore, fabricating preforms with integrated joints using these 3D weaving systems does not substantially increase the manufacturing time or cost.

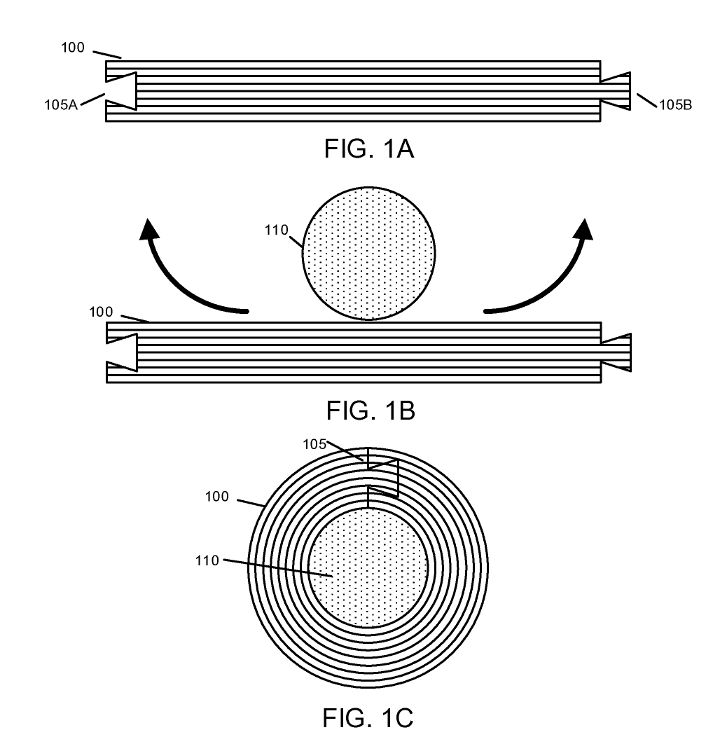

FIGS. 1A-1C illustrate an example composite preform with integrated joints that can be folded into a desired preform shape according to an embodiment of the invention. FIG. 1A illustrates a side view of an example composite preform 100 in flat or unfolded form. In this application, the term flat is used to mean lying substantially in a plane and is not intended to describe or limit the thickness of the preform, which may of any arbitrary thickness based on the design requirements and material properties. A 3D weaving system may fabricate the composite preform 100 in unfolded form to take advantage of the relatively small horizontal wall minimum thickness afforded by its 3D weaving process. Conventional 2D composite layup processes, including hand layup and automated fiber placement/automated tape layup systems, may be used to create composite preforms in alternate embodiments of the invention.

Example composite preform 100 is comprised of multiple layers of glass, carbon, aramid, or any other fiber type or types in the form of woven or non-woven fabrics. Fibers in each layer may be arranged in any orientation. The number of fiber layers and their respective fiber orientations shown in the figures is intended for illustration only and embodiments of the invention are applicable to preforms with any number of fabric layers, each of which including fibers in any orientation. Additionally, there may additional fibers or other structural elements, such as metal or composite rods, connecting fiber layers or fabric plys in the preform.

The example composite preform 100 includes integrated joint halves 105A and 105B. In an embodiment, a 3D weaving system fabricates joint halves 105A and 105B using 3D weaving as part of the fabrication of the overall preform. For example, the joint halves 105A and 105B may be fabricated in whole or in part from fibers that are woven into or otherwise connected with fibers forming the main portion of the composite preform 100. Additionally, fibers forming some or all of the main portion of the composite preform 100 may also be used to form all or a portion of the joint halves 105A and 105B. As a result, joint halves 105A and 105B are an integral part of the composite preform 100. In this example, joint halves 105A and 105B have complementary dovetail shapes; however, embodiments of the invention may utilize any interlocking to form joint halves 105A and 105B.

After the 3D weaving system has fabricated example composite preform 100 in flat form, the preform needs to be folded into its desired shape. FIG. 1B illustrates an example of the folding process. In this example, workers or machines, such as robotic manipulators, fold the composite preform 100 around a mandrel or other rigid structure 110. The composite preform can be folded easily around the rigid structure because of the relative thinness of these walls and the fact that the matrix material has either not been added to the preform or has not been cured or otherwise hardened prior to folding. In some embodiments, especially where the flat form is relatively thick, or where the material layers are thicker, it may be advantageous to take into account warping effects that occur upon folding and adjust the sizes of layers in the flat form accordingly. For example, The layers in FIG. 1A that become the progressively outer layers of the folded form can be made longer to compensate for the larger circumferences they will traverse. In general, adjustments to one or more layers of a flat form may be made in order to more precisely achieve the target shape of the folded form.

FIG. 1C illustrates the example preform 100 after folding. After folding, the integrated joint halves 105A and 105B may be connected to form a finished joint 105 and provide strength along the joint line in the finished part. Because the preform has not yet been solidified with matrix material, the joint half 105A is still relatively flexible and can be manually opened to allow insertion of joint half 105B. However, after curing, the joint 105 formed by joint halves 105A and 105B will be rigid, locking the finished joint 105 together.

In this example of FIGS. 1A-1C, the rigid structure 110 is located inside the preform 100 after folding. The rigid structure 110 may be used to give the preform shape during folding, curing, and optionally in the finished parts. Alternatively, the rigid structure 110 may be removed at any convenient stage of the part fabrication, or omitted entirely. In further embodiments of the invention, folded preforms may be located inside one or more molds or other external rigid structures and/or may include one or more mandrels, tools, or other internal rigid structures for folding and optionally curing.

Following the folding of the composite preform, the preform may be solidified by adding and/or activating a matrix material. A matrix material, such as uncured polymer resin, may be embedded in the fiber fabric or applied to or infused into the fabric during or after the fabric layup process. The matrix material is then cured or hardened, often under elevated temperature and/or pressure differentials to ensure even distribution of the matrix material and prevent voids, air bubbles, or other internal defects. Pressure, heat, and/or electromagnetic energy, such as ultraviolet light or microwave energy, may be applied to the composite part during curing using techniques including but not limited to compression molding, vacuum bags, autoclaves, inflatable bladders, and/or curing ovens.

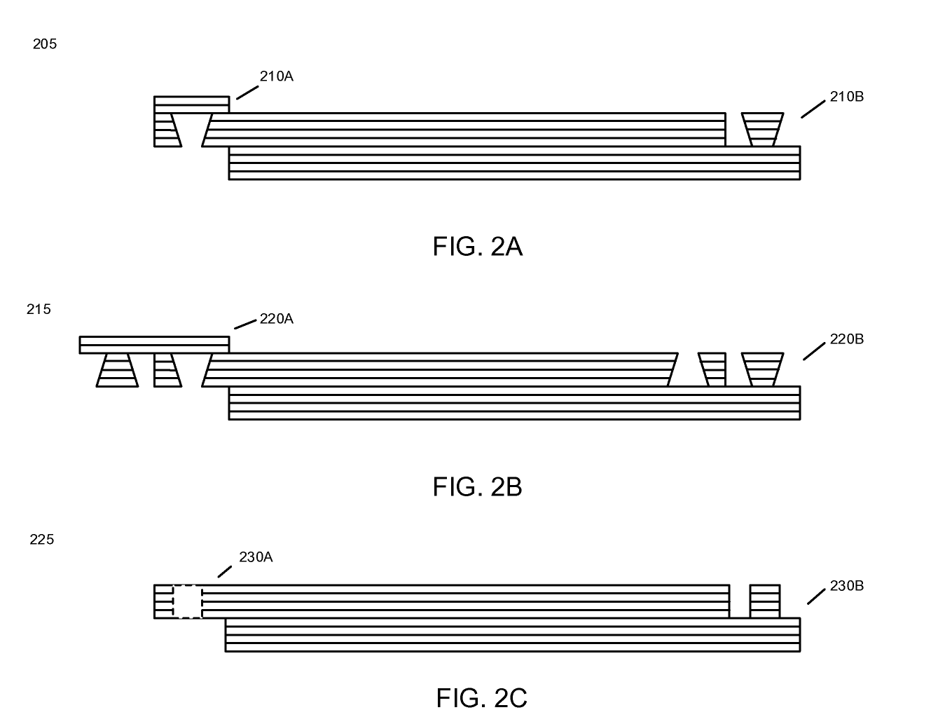

FIGS. 2A-2C illustrate example composite preforms with additional examples of integrated joints according to embodiments of the invention. FIG. 2A illustrates a composite preform 205 including an integrated lap joint comprising joint halves 210A and 210B. Lap joint halves 210A and 210B interlock together when the composite preform 205 is folded in a similar manner as shown in FIGS. 1A-1C.

FIG. 2B illustrates a composite preform 215 including an integrated double lap joint comprising joint halves 220A and 220B. Double lap joint halves 220A and 220B interlock together when the composite preform 215 is folded in a similar manner as shown in FIGS. 1A-1C.

FIG. 2C illustrates a composite preform 225 including an integrated mortise and tenon joint comprising joint halves 230A and 230B. Mortise and tenon joint halves 230A and 230B interlock together when the composite preform 225 is folded in a similar manner as shown in FIGS. 1A-1C. In a further embodiment, the tenons and optionally mortises may each include one or more holes or other receptacles for receiving pins or other structural elements (made from cured or uncured composite, metal, or other materials) to further secure the joint after folding and joint assembly.

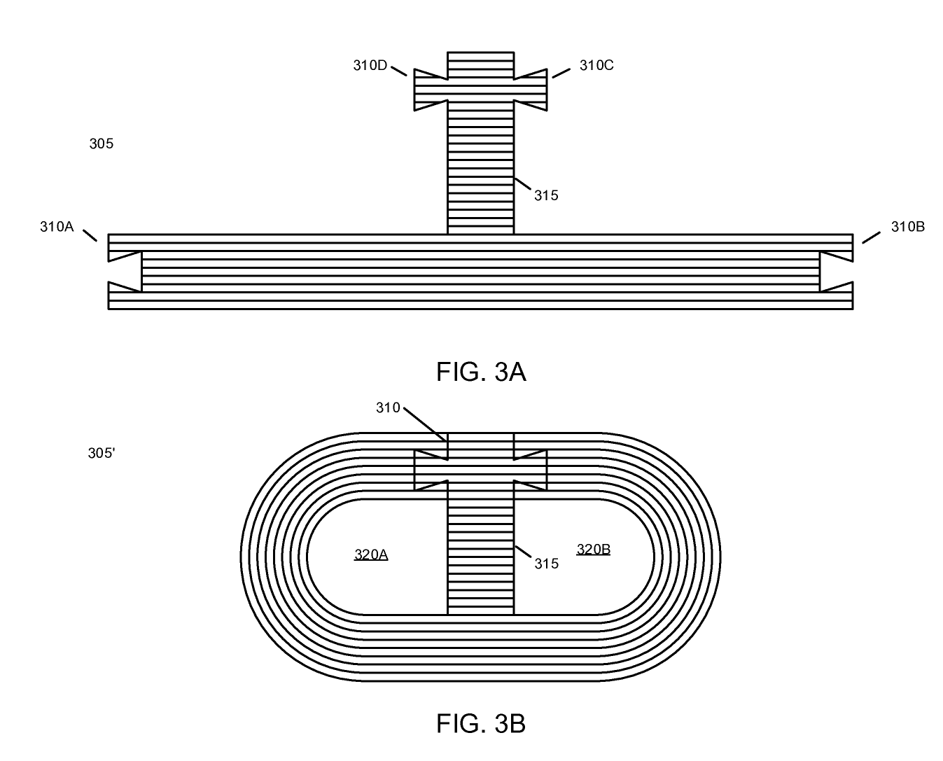

The joints illustrated in FIGS. 1A-1C and 2A-2C connect two preform edges together after folding. Further embodiments of the invention may include joints to connect three or more preform edges, such as one long preform edge connecting with adjacent two shorter preform edges or compound mortise and tenon joints. FIGS. 3A-3B illustrate an example composite preform with integrated joints and internal structure that can be folded into a desired preform shape according to an embodiment of the invention.

FIG. 3A illustrates a side view of a composite preform 305 including integrated joint ends 310A, 310B, 310C, and 310D. Joint ends 310A and 310B are integrated into the flat and foldable portion of the composite preform. Joint ends 310C and 310D are integrated into a 3D woven structure 315 that extends upwards from the foldable portion of the preform. Embodiments of the invention may include one or more 3D woven structures extending from either face of the preform. These extending 3D woven structures may include any number, type, and combination of joint ends and/or structural features. In an embodiment, the 3D woven structure 315 is fabricated with the rest of preform 305 and is an integral part of the overall preform. As an alternative to 3D weaving, alternative embodiments may use composites, metals, or other materials to fabricate structure 315 together or separately from the remainder of preform 315.

FIG. 3B illustrates the composite preform 305 after folding, forming folded preform 305′. After folding, the joint ends 310A, 310B, 310C, and 310D are all connected and interlocked to form joint 310. Additionally, in this example, the folded preform 305′ includes two internal cavities 320A and 320B, which are supported by the 3D woven structure 315.

FIGS. 1A-1C, 2A-2C, and 3A-3B are intended to illustrate some of the types of integrated joints that can be fabricated in composite preforms. However, embodiments of the invention may include any type of joint known in the art, as well as any arbitrary combinations of joints. Embodiments of the invention may include composite preforms including any number of foldable sections of any shape, with any number of joint ends of any type and arbitrary orientation, as well as zero, one, or more structures of any arbitrary shape and number of joint ends extending above or below the plane defined by the foldable sections of the preform.

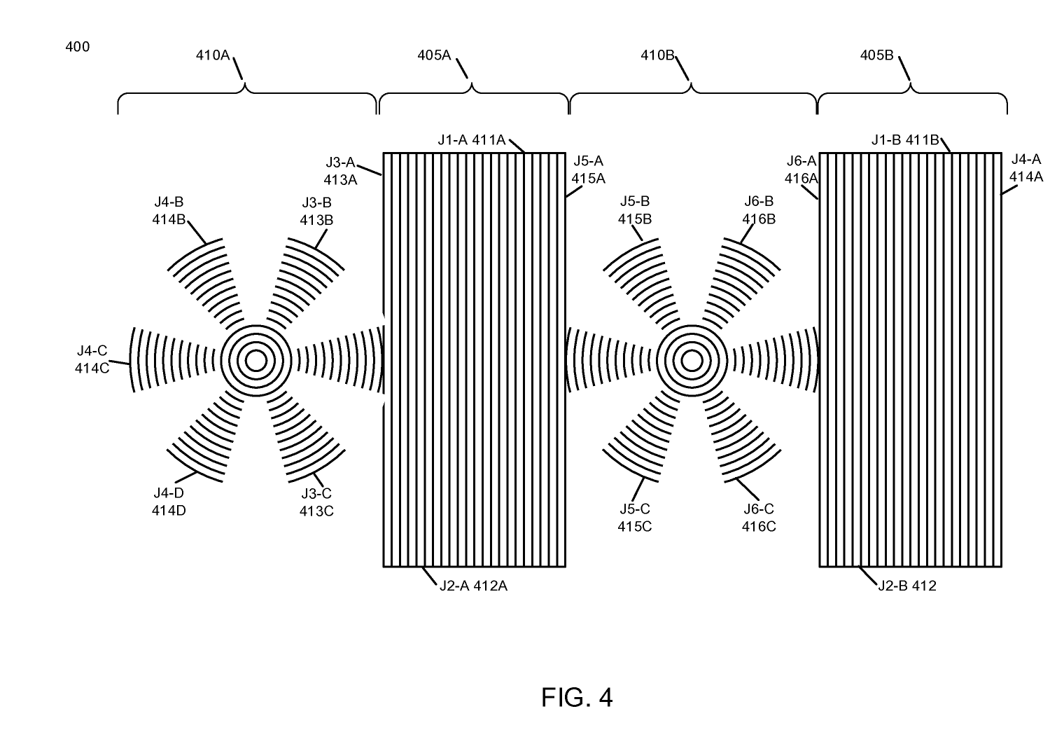

FIG. 4 illustrates an example composite preform 400 including multiple integrated joints according to an embodiment of the invention. Unlike the previous figures showing side views of the composite preform, FIG. 4 illustrates composite preform 400 from an overhead view. Composite preform 400 includes two rectangular sections 405A and 405B and two circular sections 410A and 410B. In an embodiment, the composite preform 400 and its sections 405 and 410 are all fabricated as one integral unit using 3D weaving.

In this example, all of these sections 405 and 410 are “flat” and can be folded to form a three dimensional shape, which in this example is a cylinder with domed endcaps. Preform 400 includes multiple integrated joints for connecting preform edges after folding.

Joints may be implemented using any of the structures discussed above or any other type of joint structure known in the art.

In FIG. 4, joints are indicated with the notation “JX-Y”, where X identifies the joint and Y identifies the joint end within that joint. Preform edges with the same joint identifier “JX” are connected together after folding. For example, edges J1-A 411A and J1-B 411B are connected together to form a joint along a cylindrical portion of the part. Similarly, edges J2-A 412A and J2-B 412B are connected together to form a second joint on the cylindrical portion of the part.

The edge J3-A 413A is connected with J3-B 413B and J3-C 413C, forming a connection between the cylinder wall and the base of the domed endcap. Edges J4-A 414A, J5-A 415A, and J6-A 416A are connected similarly with edges J4-B 414B and J4-C 414C; J5-B 415B and J5-C 415C; and J6-B 416B and J6-C 416C, respectively. Circular sections 410A and 410B can includes darts or cutouts to facilitate folding as well as additional integrated joints for connecting with adjacent panels, which have been omitted for clarity from FIG. 4.

Additional embodiments of the invention can include selective stiffening of the preform in areas where folding should not occur. Selective stiffening can be added to preforms during fabrication using additional material, additional material thickness, additional material reinforcements or by adding different materials to the preform.

Designers can manually create preforms in unfolded form, such as preform 400, that can be folded and assembled into complex three-dimensional shapes using conventional computer-aided design programs. However, further embodiments of the invention can include software applications and methods for generating a flat or unfolded preform pattern based on a three-dimensional preform model specifying the desired overall three-dimensional shape of the preform or completed part and optionally the desired composite fiber orientations in the completed part.

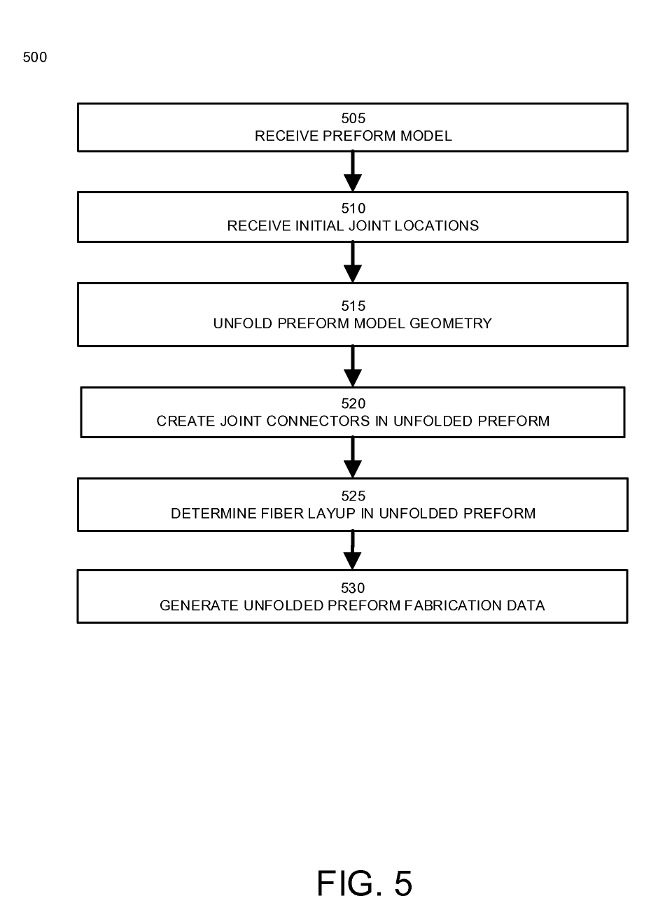

FIG. 5 illustrates a method 500 for generating unfolded preform fabrication data from a three-dimensional preform model according to an embodiment of the invention. Step 505 receives the three-dimensional preform model specifying the desired overall three-dimensional shape of the preform. The three-dimensional preform shape may be specified as three-dimensional computer graphics model data in the form of surface data, such as polygon or triangle meshes, higher-order surfaces such as NURBS or subdivision surfaces, or implicit surfaces; and/or or volumetric models, such as voxel, octree, or solid geometry models. The preform model may also optionally include desired composite fiber orientations as specified by the designer and/or engineering analysis applications. Composite fiber orientations may be included in the three-dimensional computer graphics model data or specified separately.

Step 510 receives initial joint locations from the designer. In an alternate embodiment, step 510 may receive initial joint locations from an engineering analysis based on the preform model and expected loads of the finished composite part, where the engineering analysis selects the initial joint locations to optimize the strength, weight, and/or other attributes of the composite part.

Step 515 uses these initial joint locations as a starting point for splitting and unfolding the preform model into an unfolded form. In an embodiment, the unfolded preform includes portions of the preform model reoriented so that at least one critical geometric dimension of the model is aligned with one or more fabrication system axis having the smallest minimum feature size.

Embodiments of the invention may use any type of geometric or fabric draping analysis technique known in the art for unfolding the preform model. Example techniques include generating a mesh of nodes representing the preform model; splitting the mesh along the initial joint locations; applying simulated physical forces between nodes based on geometric factors, such as the local curvature of the preform model near each of the nodes; and simulating the changes to the preform model over time under these simulated physical forces until the preform model reaches or approaches a steady state. In an additional embodiment, simulated physical forces may be based on the orientation of local portions of the preform model relative to one or more fabrication system axis having the smallest minimum feature size.

In further embodiments, portions of the preform may be designed as rigid and prevented from unfolding by holding its associated mesh nodes in place. Rigid portions of the preform may be specified by a designer and/or by comparing the geometry of the preform model with minimum feature sizes of the intended fabrication system and process, where geometry larger than a minimum feature size in its initial orientation is specified as rigid and prevented from unfolding.

Depending on the specific geometry of the preform model, it may or may not be possible to unfold the preform model into a flat or unfolded form without additional cuts or distortion. In general, a surface representing the preform model that has zero Gaussian curvature can be unfolded into a planar or flat format. These types of surfaces are referred to as developable surfaces and include, for example, cylinders and conical surfaces. Preform models having non-developable surfaces, which have non-zero Gaussian curvature, cannot be flattened or folded into a plane without distortion.

Embodiments of step 515 can work with preforms including only developable surfaces as well as those including developable and/or non-developable surfaces. For preforms including non-developable surfaces, embodiments of the invention can add darts, cutouts, or other preform modifications to the surface to minimize the distortion. Embodiments of the invention may use global and local optimization techniques, such as energy minimization, to unfold the preform and/or identify globally or locally optimal locations for cutouts and darts that minimize preform distortion after flattening. Further embodiments may also use physically-based or designer-specified limits on fabric distortion, including fabric stretching, fabric shearing, and/or variance in fiber orientation from the design, to determine where cutouts, darts, or other preform modifications are needed.

After the preform model has been unfolded into a flat shape, step 520 creates joint connectors in the preform model. Step 520 may use any type and combination of interlocking joint design known in the art, including those described above, to create joint connectors along the initial edges defined by the designer as well as along any cutouts, darts, or other preform modifications added in step 515.

Step 525 determines the fiber orientations in the unfolded preform. In an embodiment, step 525 applies the unfolding operations and distortions, if any, imposed on the preform model in step 515 for flattening the preform to the fiber orientations specified with the original preform model. Embodiments of step 525 may represent these operations by coordinate transformations or by mapping fiber orientations to nearby nodes in the original preform model and then modifying these fiber orientations based on the relative changes in positions between these nodes after unfolding in step 515.

Step 530 then generates data defining the shape of the preform in its unfolded form, its fiber orientations, and the joint connectors, referred to collectively as the unfolded preform. In one embodiment, step 530 generates one or more two-dimensional and/or three-dimensional models of the unfolded preform. These unfolded preform models may then be used to manually or automatically fabricate unfolded preforms. In another embodiment, step 530 generates one or more numerical control programs for directing one or more manufacturing systems to fabricate the unfolded preform.

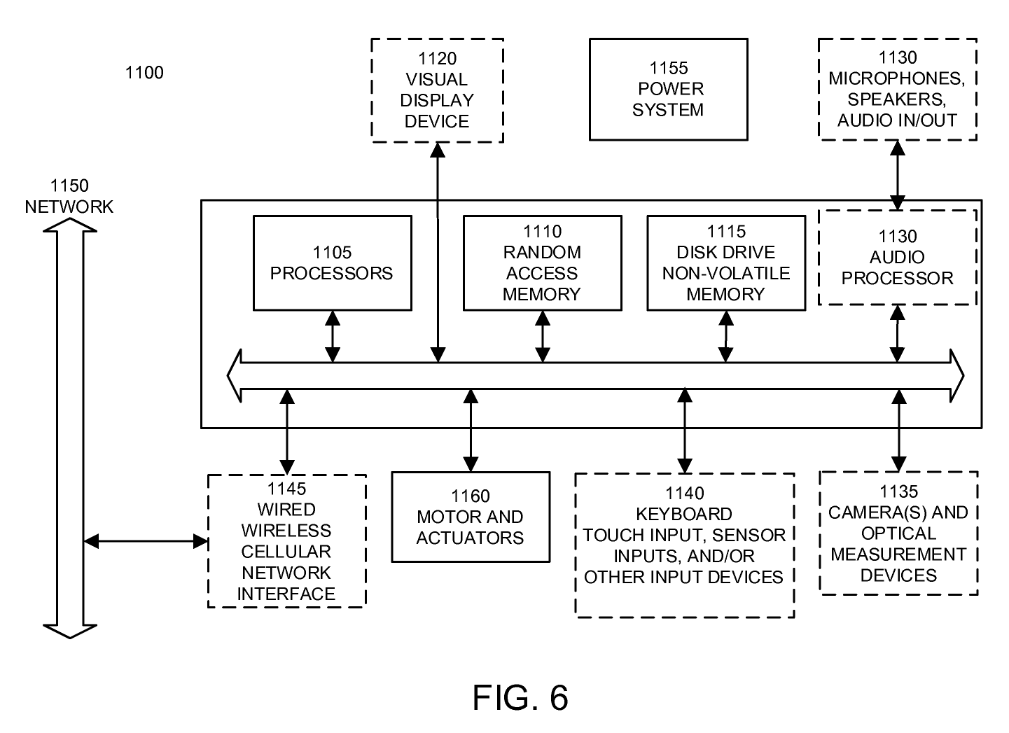

FIG. 6 illustrates a computer system suitable for controlling a system for three-dimensional weaving of composite preforms and products according to an embodiment of the invention. The computer system 1100 includes one or more general purpose or specialized processors 1105, which can include microprocessors, microcontrollers, system on a chip (SoC) devices, digital signal processors, graphics processing units (GPUs), ASICs, and other information processing devices. The computer system 1100 also includes random access memory 1110 and non-volatile memory 1115, such as a magnetic or optical disk drive and/or flash memory devices.

The computer system 1100 may optionally includes one or more visual display devices 1120. The computer system 1100 may also optionally include an audio processor 1125 for generating and receiving sound via speakers, microphone, or other audio inputs and outputs 1130; and optional sensors and input devices 1140 such as keyboards; scroll wheels; buttons; keypads; touch pads, touch screens, and other touch sensors; joysticks and direction pads; motion sensors, such as accelerometers and gyroscopes; global positioning system (GPS) and other location determining sensors; temperature sensors; mechanical, optical, magnetic or other types of position or angle detectors and/or limit switches for detecting the current positions of the various components of the above-described systems; voltage, current, resistance, capacitance, inductance, continuity, or any other type of sensor for measuring electrical characteristics of the various components of the above-described systems; force, acceleration, stress or strain, and/or tension sensors; and/or any other type of input device known in the art. Computer system 1100 may optionally include one or more cameras or other optical measurement devices 1135 for capturing still images and/or video.

The computer system 1100 may also include one or more modems and/or wired or wireless network interfaces 1145 (such as the 802.11 family of network standards) for communicating data via local-area networks 1150; wide-area networks such as the Internet; CDMA, GSM, or other cellular data networks of any generation or protocol; industrial networks; or any other standard or proprietary networks. The computer system 1100 can also include a peripheral and/or data transfer interface, such as wired or wireless USB, IEEE 1394 (Firewire), Bluetooth, or other wired or wireless data transfer interfaces.

The computer system 1100 can include a power system 1155 for obtaining electrical power from an external source, such as AC line current or DC power tailored to the computer system 1100 via an external power supply, as well as one or more rechargeable or one-time use batteries, fuel cells, or any other electrical energy generation device. Additionally, power system 1155 may provide energy in the form of compressed gas, vacuum, and/or hydraulic systems to power various actuators and components of embodiments of the invention.

Computer system 1100 may be implemented in a variety of different form factors, including desktop and laptop configurations as well as embedded and headless forms.

Embodiments of the invention use a variety of linear and rotary motors and actuators, such as brushed or brushless DC motors; AC synchronous and induction motors; stepper motors; servomotors; solenoids; leadscrews, ballscrews, or other mechanical devices for creating linear motion; and/or pneumatic and hydraulic actuators. In an embodiment, computer system 1100 include motor and actuator controls 1060 for providing power and control signals to these motors and actuators.

Further embodiments can be envisioned to one of ordinary skill in the art. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A composite preform comprising:
a foldable section;
a first joint connection section connected with the foldable section and including a first joint connector; and
a second joint connection section including a second joint connector adapted to interlock with at least a portion of the first joint connector;
wherein the first joint connection section and the foldable section are constructed at least in part from first fibers; and
wherein the second joint connection section is constructed at least in part from second fibers.

2. The composite preform of claim 1, wherein the first fibers are three-dimensionally woven to form at least portions of the first joint connection and the foldable section.

3. The composite preform of claim 1, wherein the second joint connector is connected with the foldable section and the foldable section is constructed at least in part from the second fibers.

4. The composite preform of claim 1, wherein composite preform includes at least one non-foldable section.

5. The composite preform of claim 4, wherein the second joint connector is connected with the non-foldable section and the non-foldable section is constructed at least in part from the second fibers.

6. The composite preform of claim 1, wherein the foldable section is adapted to be folded into a configuration positioning the first joint connection section adjacent to the second joint connection section, such that the first and second joint connectors are in interlocking contact.

7. The composite preform of claim 1, wherein the foldable section is adapted to be folded into a configuration conforming with a surface of a tool.

8. A method of generating a composite preform, the method comprising:
receiving a preform model specifying a desired three-dimensional shape of a composite preform;
receiving at least one initial joint location;
splitting the preform model at the initial joint location;
unfolding the preform model into an unfolded preform including at least one foldable section;
creating joint connectors in the unfolded preform along preform edges corresponding with at least the initial joint location;
determining a fiber layup of the unfolded preform; and
generating unfolded preform fabrication data.

9. The method of claim 8, wherein unfolding the preform model includes reorienting a portion of the preform model so that at least one critical geometric dimension of this portion of the preform model is aligned with a fabrication system axis having the smallest minimum feature size.

10. The method of claim 8, wherein the initial joint location is specified from a user selection.

11. The method of claim 8, wherein the initial joint location is specified from an engineering analysis.

12. The method of claim 8, wherein unfolding comprises applying simulated unfolding forces to the preform model based at least partly on geometric attributes of the preform model.

13. The method of claim 12, wherein the geometric attributes include a local attribute.

14. The method of claim 12, wherein the geometric attributes include a curvature.

15. The method of claim 12, wherein the simulated unfolding forces are based on the fiber layup and fiber properties.

16. The method of claim 8, wherein unfolding the preform model includes:
identifying at least one non-developable portion of the preform model; and
modifying the preform model to allow the non-developable portion of the preform model to be unfolded.

17. The method of claim 16, wherein modifying the preform model includes adding at least a dart to the preform model.

18. The method of claim 16, wherein modifying the preform model includes adding at least a cutout to the preform model.

19. The method of claim 16, wherein the preform model is modified at a location selected to reduce fabric distortion.

20. A computer-readable storage medium including instructions to direct a computer to perform a method comprising:
receiving a preform model specifying a desired three-dimensional shape and a fiber layup of a composite preform;
receiving at least one initial joint location;
splitting the preform model at the initial joint location;
unfolding the preform model into an unfolded preform including at least one foldable section;
creating joint connectors in the unfolded preform along preform edges corresponding with at least the initial joint location;
determining a fiber layup of the unfolded preform; and
generating unfolded preform fabrication data.
